(19) United States
(12) Patent Application Publication
(10) Pub. No.: US 2005/0063418 A1
(43) Pub. Date: Mar. 24, 2005

(54) Tuner module utilizing device-specific controller

(76) Inventor: Michael L. Case, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/670,064

(22) Filed: Sep. 23, 2003

(51) Int. Cl. H04J 3/16; H04N 7/173

(52) U.S. Cl. 370/466; 725/131

(57) ABSTRACT

A variety of different tuners can be used in a media center or other video component using a microcontroller to address each one. In one embodiment the invention includes a tuner to receive modulated video signals, the tuner having an external control interface to receive commands in a first protocol from an external agent, and a microcontroller to receive external tuner commands in a second protocol, to convert the external commands from the second protocol to the first protocol, and to transmit the converted external commands to the tuner.

### BACKGROUND

The present invention relates to the field of tuners for broadcast and multicast media and, in particular, to a tuner system in which several tuners communicate using device-specific messages through a common microcontroller.

Many current televisions, personal video recorders (PVR), video tape recorders (VTR), audio/video receivers, media centers, and similar equipment incorporate video and audio tuners. Such tuners are used for displaying, recording and tracking functions.

The number and types of tuners in any particular device can vary greatly. First, there are many different types of tuners that may be desired. Signals from terrestrial radio broadcast, cable broadcast, satellite, optic fiber and wide area networks can all use different carrier frequencies, modulation schemes and encoding. All of these sources may also provide either or both of analog or digital encoded signals. In addition, audio sources, such as AM (Amplitude Modulation) and FM (Frequency Modulation) or satellite radio can use still different signaling and encoding conventions. Further, some programming transport media or signal carriers can support two-way communications or multiple functions. NTSC (National Television Standards Committee) television signals are broadcast as receive only signals, while television coaxial cable may be used for two-way messaging, two-way broadband internet access or telephony.

Second, the standards for radio, television and other multimedia programming vary in different countries. The United States has adopted NTSC and ATSC (Advanced Television Standards Committee) standards, while Europe has adopted PAL (Phase Alternating Line) and SECAM (Systeme Couleur avec Memoire) standards, among others, and Japan uses still different standards. Even within a particular standard there may be variations with different service providers. DBS (Direct Broadcast Satellite) television tends to use standards which are very similar to but slightly different from the terrestrial television standards.

Third, the number of tuners in any particular piece of equipment can vary depending on the particular functions to be supported. For Picture-in-Picture displays and for recording one or more programs while displaying one or more others, a large number of tuners is desired. Additional tuners can also be used to obtain information, such as program guides or news while one or more other programs are being viewed. Because tuners add to the cost, power, and size of a device, the number and types of tuners is often limited. However, when the number of tuners is limited, different tuners must be provided to meet the needs of different markets, product lines and price points.

Supporting different numbers and types of tuners can add greatly to the complexity and cost of the equipment which uses the tuners. The equipment must control and command the tuners and process the signal output. Different tuners can require different configuration and command data, sometimes even when the tuners come from the same manufacturer. This requires customizing the software in the equipment for each tuner combination and configuration. While there have been some efforts to provide common communication protocols, such as I²C (Inter-Integrated Circuit, a type of bus designed by Phillips Semiconductors to connect integrated circuits), these communications protocols do not account for different configuration data, command sets and capabilities that different tuners require. While standardized languages can be used to communicate with many different tuners, the messages must still be specific to the particular tuner or tuner chipset.

### BRIEF DESCRIPTION OF THE DRAWINGS

The present invention will be understood more fully from the detailed description given below and from the accompanying drawings of various embodiments of the invention. The drawings, however, should not be taken to limit the invention to the specific embodiments, but are for explanation and understanding only.

FIG. 1 is a block diagram of a tuner module suitable for use with an embodiment of the present invention;

FIG. 2 is a signaling diagram for communications between a tuner microcontroller and a graphics system controller suitable for use with an embodiment of the present invention;

FIG. 3 is a block diagram of a media center suitable for implementing an embodiment of the present invention; and

FIG. 4 is a block diagram of an entertainment system suitable for use with the present invention.

### DETAILED DESCRIPTION

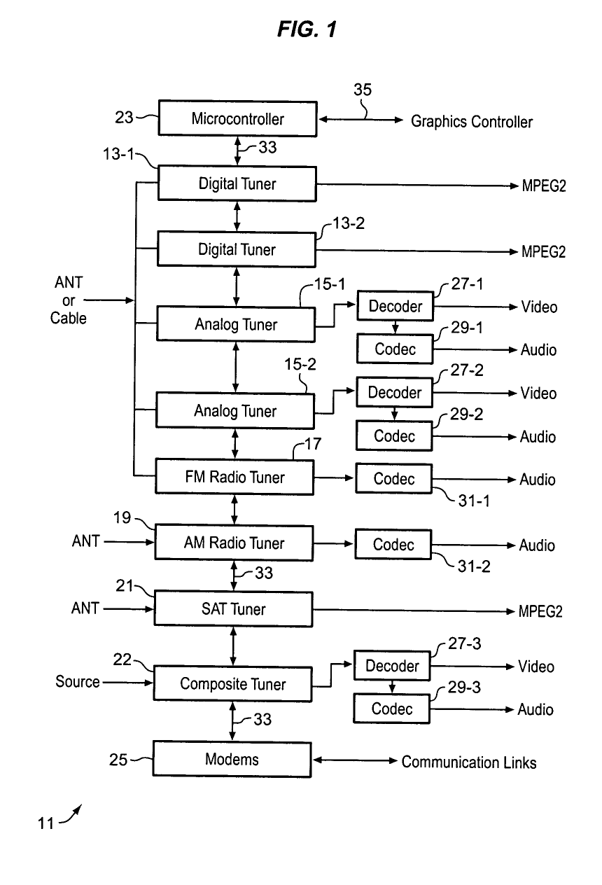

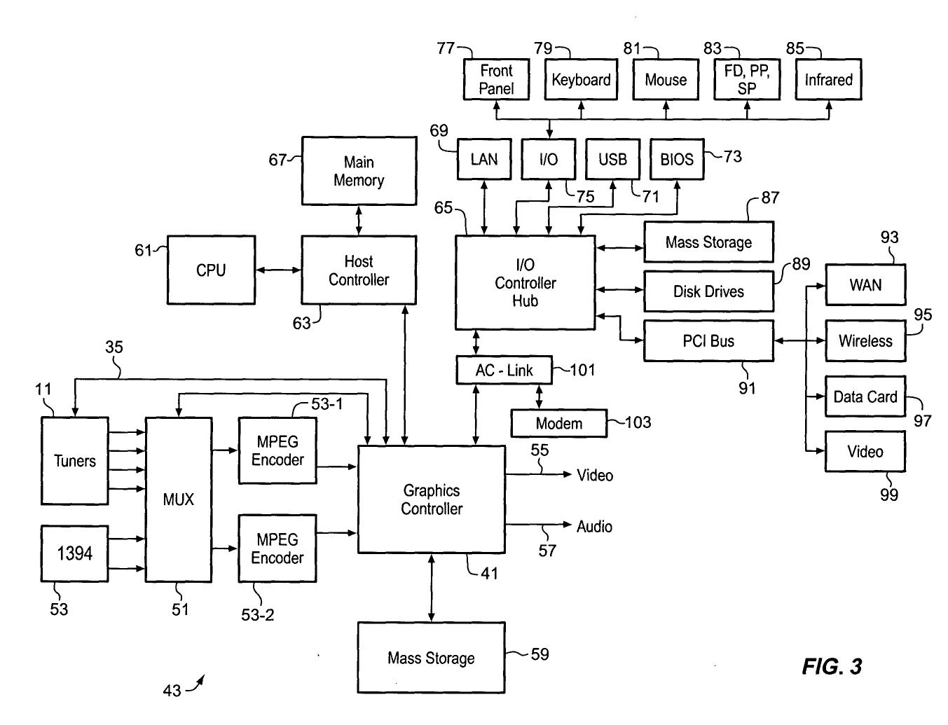

Referring to FIG. 1, a set of tuners are placed together in a single grouping, all coupled to a single microcontroller 23. The group of tuners may be placed together on a single adapter card or printed circuit board, on a single module, or wired together from disparate locations in a larger system. The tuners may also be configured in a self-contained module through the addition of power supply and other connections (not shown). The grouping may be coupled into a larger system, one example of which is the media center shown in FIG. 3. Such a system may be a television or video display, a video or audio recorder a discrete tuner for connection to an entertainment system or any of a variety of other devices.

For purposes of the present description, the grouping of tuners coupled to a single microcontroller will be referred to herein as a tuner module 11. The tuner module has a variety of different tuners. The tuners shown and described are presented as examples, more or fewer or different tuners may be used. By constructing tuner modules with different sets of tuners, a single media center design, such as that shown in FIG. 3 or a design for another device may be outfitted for different locations, capabilities and price points.

The tuner module 11 of FIG. 1 has two digital video tuners 13-1, 13-2, these may be for any one of a variety of different digital television signals, whether broadcast, multicast or point-to-point. Examples include ATSC (Advanced Television Standards Committee) signals, digital cable television signals under the variety of possible standards or any other type of digital audio or video signal. In the present example, the digital tuners are coupled to a television coaxial cable or to a terrestrial broadcast antenna and create an MPEG-2 (Motion Picture Experts Group) encoded signal for application to other components. The exact nature of the preferred output signal will depend on the particular device. As an alternative, the digital tuners can include decoders in order to produce an uncompressed digital or analog video output signal.

The tuner module also includes analog video tuners 15-1, 15-2. These tuners are also coupled to television coaxial cable or to a terrestrial broadcast antenna. In the present example, the tuners down-convert and demodulate the received signals to obtain a standard NTSC (National Television Standards Committee), PAL (Phase Alternating Line) signal, or any other type of analog television output. This signal can be applied to a decoder 27-1, 27-2 to convert the analog output to a digital television video signal, such as an ITU-R BT 656 (International Telecommunications Union-Radiocommunications sector standard for digital video) or any other type of video signal. The audio portion derived from the decoder can be applied to a codec (coder/decoder) 29-1, 29-2 for sampling and conversion to digital sound, such as I²S (Inter-IC Sound, a type of bus designed by Phillips Semiconductors to carry digital audio) or any other type of audio signal. Converting the analog signals to digital video and audio allows the resulting video to be handled in a similar way to the MPEG-2 signals from the digital tuners.

The tuner module may also include an FM radio tuner 19 and an AM radio tuner coupled to the same or different antennas. The radio tuners generate an analog audio output that may also be converted in separate analog to digital conversion codecs 31-1, 31-2 to digital 1²S audio signals. If the signals contain RIS (Radio Data System), PTY (Program Type) data, or other embedded or sideband data, this data can be extracted and rendered as video or in some other way to the larger system.

The tuner module may also contain a DBS tuner 21 or any other type of satellite tuner coupled to a satellite antenna. The DBS tuner produces a digital MPEG-2 output that may be transmitted directly to the larger system. Analog satellite systems may be accommodated in the same way as the analog terrestrial broadcast tuners described above.

A composite video tuner is also shown. Such a device can allow the system to receive video and audio signals from a video recorder, camera, external tuner, or any other device. This signal may then be processed through a decoder 27-3 and codec 29-3, in the same way as the other analog signals. Such a tuner allows the signals from other external devices to be processed by the larger system in the same way as all the other signals. For example, with a television monitor, the composite video tuner can allow the monitor to easily be switched from a digital cable broadcast to a home movie being played on a connected video camera. Picture-in-Picture and many other features may also be supported. A great variety of different connectors may be used for this tuner from coaxial cables to RCA component video, S-Video, DIN connectors, DVI (digital video interface), HDMI (High Definition Multimedia Interface), VGA (Video Graphics Adapter), and more.

Each of the tuners is connected through a control line 33 to a microcontroller 23. The microcontroller may be any of a variety of different types. Suitable microcontrollers include the Intel® 8051, or any Intel® XScale™ technology microcontrollers, however the invention is not so limited. These microcontrollers have integrated I²C (Inter-IC) and SPI (Serial Peripheral Interface) communications capabilities. They may be programmed to communicate with many different tuners and other components. Alternatively, an ASIC (Application Specific Integrated Circuit) or other firmware programmed device may be used. In one embodiment, the tuners are on a daisy-chained I²C control bus 33 which allows the microcontroller to address each tuner individually at any time using assigned addresses, however, any other communications interface or protocol may be used. The microcontroller may be designed with a unique device-specific interface for each tuner or it may operate through I/O interfaces with some or all of the tuners. The microcontroller transmits control and command data to the tuners and modem and performs system maintenance, management, and power control.

The microcontroller may be provided with a program stack with all of the vendor and device-specific configuration required by each tuner. This information may include carrier frequencies, electronic program data source information, configuration registers and any other information desired to control and implement the capabilities of each tuner. In another embodiment, the microcontroller is coupled to a PROM (Programmable Read Only Memory, not shown) which contains all of the program stack and configuration data for each anticipated configuration. The microcontroller is the same for all configurations, but the instructions and data in the PROM are designed specifically for a particular tuner configuration.

For some tuners, there may be additional functions to be supported. For example, some cable and satellite systems require a telephone connection to the PSTN (Public Switched Telephone Network) or to the Internet in order to process billing and subscription information or to order pay-per-view events. Some cable systems use a return signal to the cable head end for the same purpose. Some consumer electronic devices, such as video recorders have a supplemental control connection for commands or timing information. There are also external sources of electronic programming guide (EPG) or station information that can be obtained from dial-up services or from the Internet. Any one or more of these services may use modems 25 in the tuner module 11 that are also daisy-chained to the control line 33 up to the microcontroller 23. For example, if a viewer wishes to order a particular movie, the microcontroller may issue a command to the tuner which may respond that it requires access to its dial-up ordering service. The tuner may either address the appropriate modem directly or address it through the microcontroller. As an alternative, any necessary modems may be incorporated into the corresponding tuner. As another alternative, a tuner may access a modem in the larger system, to which the tuner module is attached, through the microcontroller.

The microcontroller also has a communications interface to a graphics controller that is a part of the larger system to which the tuner module is coupled. This connection may be a line in a printed circuit board, a line through a socket connector on a standardized bus, a card-specific connector for the tuner module, or a standardized I/O interface, such as USB (Universal Serial Bus) or IEEE 1394 (Institute of Electronics and Electrical Engineers standard for high speed serial I/O communications). It may also be a radio connection using any number of different protocols. In one embodiment, an I²C connection may be used and shared with any number of other components. The graphics controller may be implemented using any of a variety of different processors or ASICs. Some examples include the ST Microelectronics® Sti70 15/20, the Zoran®) TL8xx, or Generation 9, and the ATi® Technologies Xilleon™ lines of processors. The graphics controller may be the central processor for the larger system or coupled to a separate CPU, as shown in FIG. 3.

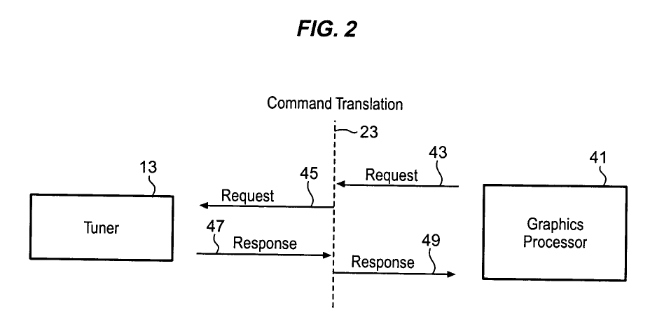

As shown in FIG. 2, the graphics controller 41, sends generalized instructions to the microcontroller 23, which reinterprets them in the device-specific manner required by the particular device addressed 13, either a tuner or the modem. For example, the graphics controller could request an EPG update through the tuner module. The microcontroller may command the appropriate modem to obtain the desired update and this information may be returned to the graphics controller through the microcontroller or on a separate line.

FIG. 2 shows a general message exchange that may be applied to many different messages. One such message is a sequence for changing channels. The graphics controller 41 may send a request 43 to change the television channel on tuner 2 up one channel. This will be sent by the graphics controller in a generalized format using the protocol that is appropriate for communication between the two devices. The request may be sent without any regard to the configuration of the tuner. The microcontroller 23 may determine which of the tuners is tuner 2, access the appropriate configuration data and generate a device-specific request 45. This request may include the control line address for tuner 2 and an instruction to move to the next channel up using the appropriate device-specific commands. These commands will be in the appropriate protocol for the selected tuner and formatted specifically for the tuner. In this way, the microcontroller has converted the generalized request to a device-specific one.

As an example, in one embodiment of the invention, the graphics controller might send an instruction over the I²C bus to the microcontroller to tune an analog television tuner to NTSC channel A14. The microcontroller first looks through its configuration data to select the appropriate analog tuner and determine its address. It then determines that channel A14 corresponds to a carrier frequency of 471.25 MHz+45.75 MHz=517.00 MHz. The microcontroller then may create a command for the selected tuner.

For one type of tuner, this command is generated using table look-up as a set of hexadecimal data bytes that can be transferred over an I²C bus to the selected tuner. The data bytes may be generated from a look-up table or derived using a device-specific instruction set. In one example, the command is converted into a command sequence of Divider Byte 1=20, Divider Byte 2=50, Command Byte=86, Bandswitch Byte=44. This packet is transferred to the tuner which then interprets the commands as an instruction to tune to the designated channel. The particular selection and formatting of codes for the instruction to tune to channel A14 may differ with different tuners and the microcontroller may be programmed or configured to accommodate any such differences.

The tuner upon having completed the requested task may send a response 47 indicating the that it has changed channels and indicating perhaps the channel to which it has tuned. This communication will, again, be in a device-specific format. The microcontroller converts this into a generic protocol and sends a response 49 back to the graphics processor. In this way, the graphics controller may operate in exactly the same way regardless of the make or model of tuner employed.

FIG. 3 shows a block diagram of a media center 43 suitable for using the tuner module described above. In FIG. 3, the tuner module 11 is coupled to the graphics controller using e.g. an I²C interface as described above. The multiple video and audio outputs described with respect to FIG. 1 are coupled to a multiplexer 51. Other sources may also be coupled to the multiplexer, if desired, for example an IEEE 1394 appliance 53 is shown as also being coupled to the multiplexer. Some such devices might include, tape players, disk players and MP3 players, among others. The multiplexer, under control of the graphics controller selects which of the tuner or other inputs will be connected to the rest of the media center.

The selected tuner inputs are coupled to the multiplexer outputs. These multiplexer outputs are, in the present example, routed each to respective MPEG-2 encoders 53-1, 53-2 and then to the graphics controller 41. In the case of the digital television, radio, digital cable or satellite signals, the multiplexer may route the signals around the MPEG-2 encoders or disable the encoding process as these signals are already encoded.

From the graphics controller, the video and audio signals may be output for display, storage, or recording. In one embodiment, the graphics controller contains MPEG-2 and MPEG-3 decoders as well as a video signal processor to format video and audio signals for use by the desired appliance and to combine command, control, menu, messaging and other images with the video and audio from the tuners. The graphics controller may drive the entire device or operate only for graphics functions under control of another higher level processor, as described below.

For simplicity, FIG. 3 shows only one video output and one audio output, however, the number and variety of outputs may vary greatly depending on the particular application. If the media center is to function as a tuner, then a single DVI, or component video output, together with a single digital audio output, such as an optical S/PDIF (Sony/Philips Digital Interface) output, may suffice. In the configuration shown, the media center may be used as a tuner with picture-in-picture displays on a monitor or it may be used to record one channel while showing another. If the media center is to serve more functions then additional audio and video connections may be desired of one or more different types.

The actual connectors and formats for the video and audio connections may be of many different types and in different numbers. Some connector formats include coaxial cable, RCA composite video, S-Video, component video, DIN (Deutsche Industrie Norm) connectors, DVI (digital video interface), HDMI (High Definition Multimedia Interface), VGA (Video Graphics Adapter), and even USB and IEEE 1394. There are also several different proprietary connectors which may be preferred for particular applications. The types of connectors may be modified to suit a particular application or as different connectors become adopted.

The media center may also include a mass storage device, such as a hard disk drive, a volatile memory, a tape drive (e.g. for a VTR) or an optical drive. This may be used to store instructions for the graphics controller, to maintain an EPG (Electronic Program Guide) or to record audio or video received from the tuner module.

While the components described above are sufficient for many consumer electronics, home entertainment and home theater devices, such as tuners (terrestrial, cable, and satellite set-top boxes), VTR's, PVR's, and televisions, among others. Further functionality may be provided using some of the additional components described below. In addition, preamplifier and power amplifiers, control panels, or displays (not shown) may be coupled to the graphics controller as desired.

The media center may also include a CPU (Central Processing Unit) 61 coupled to a host controller 63 or chipset. Any number of different CPU's and chipsets may be used. In one embodiment a Mobile Intel® Celeron® processor with an Intel® 830 chipset is used, however the invention is not so limited. It offers more than sufficient processing power, connectivity and power saving modes. The host processor has a north bridge coupled to an I/O controller hub (ICH) 65, such as an Intel® FW82801 DB (ICH4), and a south bridge coupled to on-board memory 67, such as RAM (Random Access Memory). The chipset also has an interface to couple with the graphics controller 41. Note that the invention is not limited to the particular choice of processor suggested herein.

The ICH 65 offers connectivity to a wide range of different devices. Well-established conventions and protocols may be used for these connections. The connections may include a LAN (Local Area Network) port 69, a USB hub 71, and a local BIOS (Basic Input/Output System) flash memory 73. A SIO (Super Input/Output) port 75 can provide connectivity for a front panel 77 with buttons and a display, a keyboard 79, a mouse 81, and infrared devices 85, such as IR blasters or remote control sensors. The I/O port can also support floppy disk, parallel port, and serial port connections. Alternatively, any one or more of these devices may be supported from a USB, PCI or any other type of bus.

The ICH can also provide an IDE (Integrated Device Electronics) bus for connections to disk drives 87, 89 or other large memory devices. The mass storage may include hard disk drives and optical drives. So, for example, software programs, user data, EPG data and recorded entertainment programming can be stored on a hard disk drive or other drive. In addition CD's (Compact Disk), DVD's (Digital Versatile Disk) and other storage media may be played on drives coupled to the IDE bus.

A PCI (Peripheral Component Interconnect) bus 91 is coupled to the ICH and allows a wide range of devices and ports to be coupled to the ICH. The examples in FIG. 3 include a WAN (Wide Area Network) port 93, a Wireless port 95, a data card connector 97, and a video adapter card 99. There are many more devices available for connection to a PCI port and many more possible functions. The PCI devices can allow for connections to local equipment, such as cameras, memory cards, telephones, PDA's (Personal Digital Assistant), or nearby computers. They can also allow for connection to various peripherals, such as printers, scanners, recorders, displays and more. They may also allow for wired or wireless connections to more remote equipment or any of a number of different interfaces. The remote equipment may allow for communication of programming or EPG data, for maintenance or remote control or for gaming, Internet surfing or other capabilities.

Finally, the ICH is shown with an AC-Link (Audio Codec Link) 101, a digital link that supports codecs with independent functions for audio and modem. In the audio section, microphone input and left and right audio channels are supported. In the example of FIG. 3, the AC-Link supports a modem 103 for connection to the PSTN, as well as an audio link to the graphics controller 41. The AC-Link carries any audio generated by the CPU, Host Controller or ICH to the graphics controller for integration with the audio output 57. Alternatively, an ISA (Industry Standard Architecture) bus, PCI bus or any other type connection may be used for this purpose. As can be seen from FIG. 3, there are many different ways to support the signals produced by the tuner and to control the operation of the tuners. The architecture of FIG. 3 allows for a wide range of different functions and capabilities. The particular design will depend on the particular application.

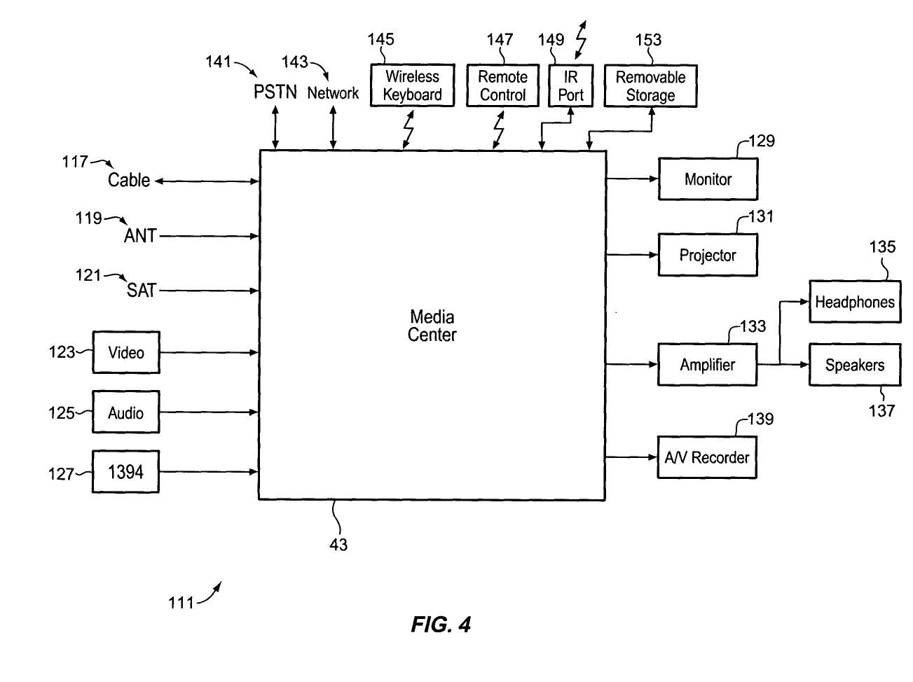

FIG. 4 shows a block diagram of an entertainment system 111 suitable for use with the media center of FIG. 3. FIG. 4 shows an entertainment system with a wide range of installed equipment. This equipment is shown as examples of many of the possibilities. The present invention may be used in a much simpler or still more complex system. The media center as described in FIG. 3, is able to support communication through WAN and LAN connections, Bluetooth, IEEE 802.11 USB, 1394, IDE, PCI, and Infrared. In addition, the tuner module receives inputs from antennas, component, and composite video and audio and IEEE 1394 devices. This provides extreme flexibility and variety in the types of devices that may be connected and operate with the media center. Other interfaces may be added or substituted for those described as new interfaces are developed and according to the particular application for the media center. Many of the connections may be removed to reduce cost. The specific devices, shown in FIG. 4 represent one example of a configuration that may be suitable for a consumer home entertainment system.

The media center 43 has several different possible inputs as described above. In the example of FIG. 4, these include a television cable 117, a broadcast antenna 119, a satellite receiver 121, a video player 123, such as a tape or disk player, an audio player 125, such as a tape, disk or memory player, and a digital device 127, connected for example by an IEEE 1394 connection.

These inputs, after processing, selection and control may be used to generate outputs for a user. The outputs may be rendered on a monitor 129, or projector 131, or any other kind of perceivable video display. The audio portion may be routed through an amplifier 133, such as an A/V receiver or a sound processing engine, to headphones 135, speakers 137 or any other type of sound generation device. The outputs may also be sent to an external recorder 139, such as a VTR, PVR, CD or DVD recorder, memory card etc.

The media center also provides connectivity to external devices through, for example a telephone port 141 and a network port 143. The user interface is provided through, for example, a keyboard 145, or a remote control 147 and the media center may communicate with other devices through its own infrared port 149. A removable storage device 153 may allow for MP3 compressed audio to be stored and played later on a portable device or for camera images to be displayed on the monitor 129.

There are many different equipment configurations for the entertainment center using the media center of FIG. 3 and many different possible choices of equipment to connect. A typical home entertainment system, using typical currently available equipment, might be as follows. As inputs, this typical home entertainment system might have a television antenna 119 and either a cable television 117 or DBS 121 input to the tuner module of the media center. A VTR or DVD recorder might be connected as an input device 123 and an output device 139. A CD player 125 and an MP3 player 127 might be added for music. Such a system might also include a wide screen high definition television 129, and a surround sound receiver 133 coupled to six or eight speakers 137. This same user system would have a small remote control 147 for the user and offer remote control 149 from the media center to the television, receiver, VTR, and CD player. An Internet connection 141 and keyboard 145 would allow for web surfing, upgrades and information downloads, while a computer network would allow for file swapping and remote control from or to a personal computer in the house.

It is to be appreciated that a lesser or more equipped entertainment system and media center than the example described above may be preferred for certain implementations. Therefore, the configuration of the entertainment system and media center will vary from implementation to implementation depending upon numerous factors, such as price constraints, performance requirements, technological improvements, or other circumstances. Embodiments of the invention may also be applied to other types of software-driven systems that use different hardware architectures than that shown in FIGS. 3 and 4.

In the description above, for purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

The present invention may include various steps. The steps of the present invention may be performed by hardware components, such as those shown in FIGS. 1, 3, and 4, or may be embodied in machine-executable instructions, which may be used to cause general-purpose or special-purpose processor or logic circuits programmed with the instructions to perform the steps. Alternatively, the steps may be performed by a combination of hardware and software.

The present invention may be provided as a computer program product which may include a machine-readable medium having stored thereon instructions which may be used to program a media center (or other electronic devices) to perform a process according to the present invention. The machine-readable medium may include, but is not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem or network connection).

Many of the methods and apparatus are described in their most basic form but steps may be added to or deleted from any of the methods and components may be added or subtracted from any of the described apparatus without departing from the basic scope of the present invention. It will be apparent to those skilled in the art that many further modifications and adaptations may be made. The particular embodiments are not provided to limit the invention but to illustrate it. The scope of the present invention is not to be determined by the specific examples provided above but only by the claims below.

1. An apparatus comprising:
a tuner to receive modulated video signals, the tuner having an external control interface to receive commands in a first protocol from an external agent; and
a microcontroller to receive external tuner commands in a second protocol, to convert the external commands from the second protocol to the first protocol, and to transmit the converted external commands to the tuner.

2. The apparatus of claim 1, wherein the tuner further generates command responses in the first protocol and wherein the microcontroller receives the command responses, converts them to the second protocol and transmits the converted command responses.

3. The apparatus of claim 1, further comprising a second tuner to receive modulated video signal, the second tuner having an external interface to receive commands in a third protocol, and wherein the microcontroller receives external commands for the second tuner in the second protocol, converts them to the third protocol, and transmits them to the second tuner.

4 The apparatus of claim 1, wherein the tuner further comprises an input/output interface to communicate data and control signals in the first protocol to external devices and wherein the microcontroller is coupled to the input/output interface to convert data and control signals between the first protocol and the second protocol.

5. The apparatus of claim 1, further comprising a system processor coupled to the microprocessor to generate the commands in the first protocol to control the tuner.

6. The apparatus of claim 1, further comprising a look-up table for the tuner and wherein the microcontroller converts the external tuner commands by applying the commands in the second protocol to the look-up table.

7. The apparatus of claim 1, further comprising an instruction stack specific for the tuner and wherein the microcontroller converts the external tuner commands by applying instructions from the tuner-specific instruction stack.

8. A method comprising:
receiving at a microcontroller from an external agent commands in a second protocol for a tuner;
converting the external tuner commands from the second protocol to a first protocol; and
transmitting the commands to an external control interface of the tuner in the first protocol.

9. The method of claim 8, further comprising:
receiving command responses in the first protocol at the microcontroller from the tuner;
converting the received command response to the second protocol; and
transmitting the converted command responses to the external agent.

10. The method of claim 8, further comprising:
receiving at the microcontroller from an external agent commands in the second protocol for a second tuner;
converting the second tuner external commands to a third protocol; and
transmitting the third protocol commands to the second tuner.

11. The method of claim 8, wherein converting the external tuner commands comprises applying the commands in the second protocol to a look-up table.

12. The method of claim 8, wherein converting the external tuner commands comprises applying instructions from a tuner-specific instruction stack.

13. An article comprising a machine-readable medium having stored thereon data representing instructions which, when executed by a machine, cause the machine to perform operations comprising:
receiving at a microcontroller from an external agent commands in a second protocol for a tuner;
converting the external tuner commands from the second protocol to a first protocol; and
transmitting the commands to an external control interface of the tuner in the first protocol.

14. The medium of claim 13, further comprising instructions which, when executed by the machine, cause the machine to perform further operations comprising:
receiving command responses in the first protocol at the microcontroller from the tuner;
converting the received command responses to the second protocol; and
transmitting the converted command responses to the external agent.

15. The medium of claim 13, further comprising instructions which, when executed by the machine, cause the machine to perform further operations comprising:
receiving at the microcontroller from the external agent commands in the second protocol for a second tuner;
converting the second tuner external commands to a third protocol; and
transmitting the third protocol commands to the second tuner.

16. The medium of claim 13, wherein the instructions for converting the external tuner commands comprise instructions which, when executed by the machine, cause the machine to perform further operations comprising applying the commands in the second protocol to a look-up table.

17. The method of claim 13, wherein the instructions for converting the external tuner commands comprise instructions which, when executed by the machine, cause the machine to perform further operations comprising applying instructions from a tuner-specific instruction stack.

18. A video tuner comprising:
a system processor to receive user commands and to control at least one tuner;
a tuner to receive wireless video signals modulated over a carrier frequency, the tuner having an external control interface to receive commands in a first protocol from an external agent; and
a microcontroller to receive tuner commands from the system processor in a second protocol, to convert them from the second protocol to the first protocol, and to transmit them to the tuner.

19. The tuner of claim 18, wherein the tuner further generates command responses in the first protocol and wherein the microcontroller receives the command responses, converts them to the second protocol and transmits the converted command responses to the system controller.

20. The tuner of claim 18, further comprising a second tuner to receive modulated video signals, the second tuner having an external interface to receive commands in a third protocol, and wherein the microcontroller receives second tuner commands from the system processor for the second tuner in the second protocol, converts them to the third protocol, and transmits them to the second tuner.

21 The tuner of claim 18, wherein the tuner further comprises an input/output interface to communicate data and control signals in the first protocol to external devices and wherein the microcontroller is coupled to the input/output interface to convert data and control signals between the first protocol and the second protocol.

22. The tuner of claim 18, further comprising a look-up table for the tuner and wherein the microcontroller converts the tuner commands by applying the commands in the second protocol to the look-up table.

23. The tuner of claim 18, further comprising an instruction stack specific for the tuner and wherein the microcontroller converts the external tuner commands by applying instructions from the tuner-specific instruction stack.
